(19) United States
(12) Patent Application Publication
(10) Pub. No.: US 2026/0323277 A1
(43) Pub. Date: Oct. 15, 2026

(54) METHOD, DEVICE AND COMPUTER PROGRAM PRODUCT FOR WIRELESS COMMUNICATION

(71) Applicant: ZTE CORPORATION, Shenzhen, Guangdong (CN)

(72) Inventors: Yuze LIU, Shenzhen (CN); Shilin YOU, Shenzhen (CN); Peilin LIU, Shenzhen (CN); Leyi ZHANG, Shenzhen (CN); Wei MA, Shenzhen (CN)

(21) Appl. No.: 19/482,316

(22) PCT Filed: Jul. 19, 2023
(86) PCT No.: PCT/CN2023/108200

§ 371 Date: Nov. 7, 2025

(51) Int. Cl. H04W 12/033; H04W 8/24; H04W 12/041

(52) U.S. Cl. CPC H04W 12/033; H04W 8/24; H04W 12/041

(57) ABSTRACT

A wireless communication method is disclosed. The method comprises receiving, by a first wireless communication node from a wireless communication terminal, an uplink message for a user plane connection between the wireless communication terminal and a second wireless communication node; and transmitting, by the first wireless communication node to the wireless communication terminal, security related information in response to the uplink message to allow the wireless communication terminal to establish or update the user plane connection between the wireless communication terminal and a second wireless communication node, wherein the user plane connection is protected based on the security related information.

### CROSS-REFERENCE TO RELATED APPLICATION

This is a national stage application filed under 37 U.S.C. 371 based on International Patent Application No. PCT/CN2023/108200, filed Jul. 19, 2023, the disclosure of which is incorporated herein by reference in its entirety.”

### TECHNICAL FIELD

This document is directed generally to wireless communications, and in particular to 5th generation (5G) communications or 6th generation (6G) communications.

### BACKGROUND

User plane connection refers to the dedicated communication path established between a User Equipment (UE) and the network for the transmission of user data. It serves as the conduit for delivering information such as voice, video, and data packets between the UE and the network components, including the Access and Mobility Management Function (AMF), Session Management Function (SMF), User Plane Function (UPF), and ultimately, the destination. The user plane connection ensures efficient and reliable data transmission, supporting high-speed and low-latency communication services in the network. However, a secured user plane connection for a positioning related service is still a topic to be discussed.

This document relates to methods, systems, and computer program products for a wireless communication.

One aspect of the present disclosure relates to a wireless communication method. In an embodiment, the wireless communication method includes: receiving, by a first wireless communication node from a wireless communication terminal, an uplink message for a user plane connection between the wireless communication terminal and a second wireless communication node; and transmitting, by the first wireless communication node to the wireless communication terminal, security related information in response to the uplink message to allow the wireless communication terminal to establish or update the user plane connection between the wireless communication terminal and a second wireless communication node, wherein the user plane connection is protected based on the security related information.

### SUMMARY

Various embodiments may preferably implement the following features:

Preferably, the security related information comprises at least one of:
a key for the user plane connection;
an identifier of a key for the user plane connection;
a key derivation indicator indicating the wireless communication terminal to derive a key for the user plane connection; or
a valid period of a key for the user plane connection.

Preferably, the method further comprises:
receiving, by the first wireless communication node from the second wireless communication node, user plane information indicating the wireless communication terminal performing the positioning via the user plane connection.

Preferably, the user plane information comprises at least one of:
an identifier of the wireless communication terminal;
an identifier of a key for the user plane connection; or
a key for the user plane connection.

Preferably, the method further comprises:
transmitting, by the first wireless communication node to the second wireless communication node, a request message comprising an identifier of the wireless communication terminal.

Preferably, the method further comprises:
receiving, by the first wireless communication node from the second wireless communication node, a key for the user plane connection and an identifier of the key for the user plane connection; and
transmitting, by the first wireless communication node to the wireless communication terminal, the key for the user plane connection and the identifier of the key for the user plane connection.

Preferably, the method further comprises:
receiving, by the first wireless communication node from the wireless communication terminal, an identifier of a first key;
transmitting, by the first wireless communication node to the second wireless communication node, the identifier of the first key;
receiving, by the first wireless communication node from the second wireless communication node, at least one of: the first key serving as the key for the user plane connection, the identifier of the first key, a valid period of the first key a second key serving as an updated key for the user plane connection, the identifier of the second key, or a valid period of the second key; and
transmitting, by the first wireless communication node to the wireless communication terminal, at least one of: the first key, the identifier of the first key, the valid period of the first key, the second key, the identifier of the second key, or the valid period of the second key.

Preferably, the method further comprises:
receiving, by the first wireless communication node from the wireless communication terminal, a key refresh request via the uplink message, wherein the key refresh request comprises at least one of an identifier of the second wireless communication node or a key identifier;
transmitting, by the first wireless communication node to the second wireless communication node, the key refresh request;
receiving, by the first wireless communication node from the second wireless communication node, at least one of: an updated key for the user plane connection, the identifier of
the updated key, or a valid period of the updated key; and transmitting, by the first wireless communication node to the wireless communication terminal, at least one of: the updated key, the identifier of the updated key, or the valid period of the updated key.

Preferably, the method further comprises:
selecting, by the first wireless communication node, the second wireless communication node based on at least one of the identifier of the first key or an identifier of the wireless communication terminal.

Preferably, the method further comprises:
receiving, by the first wireless communication node from the wireless communication terminal, a key identifier;
acquiring, by the first wireless communication node, a key corresponding to the key identifier;
transmitting, by the first wireless communication node to the second wireless communication node, the key and the key identifier; and
transmitting, by the first wireless communication node to the wireless communication terminal, a key derivation indicator indicating the wireless communication terminal to derive the key corresponding to the key identifier.

Preferably, the method further comprises:
generating, by the first wireless communication node, the key corresponding to the key identifier according to at least one of: an uplink non-access stratum, NAS, count, a key for a communication between the first wireless communication node and the wireless communication terminal, or a Subscription Permanent Identifier, SUPI.

Another aspect of the present disclosure relates to a wireless communication method. In an embodiment, the wireless communication method includes: transmitting, by a wireless communication terminal to a first wireless communication node, an uplink message for a user plane connection between the wireless communication terminal and a second wireless communication node; receiving, by the wireless communication terminal from the first wireless communication node, security related information; and establishing or updating, by the wireless communication terminal, the user plane connection between the wireless communication terminal and the second wireless communication node, wherein the user plane connection is protected based on the security related information.

Various embodiments may preferably implement the following features:

Preferably, the security related information comprises at least one of:
a key for the user plane connection;
an identifier of a key for the user plane connection;
a key derivation indicator indicating the wireless communication terminal to derive a key for the user plane connection; or
a valid period of a key for the user plane connection.

Preferably, the method further comprises:
receiving, by the wireless communication terminal from the first wireless communication node, user plane information indicating the wireless communication terminal performing the positioning via the user plane connection.

Preferably, the user plane information comprises at least one of:
an identifier of the wireless communication terminal;
an identifier of a key for the user plane connection; or
a key for the user plane connection.

Preferably, the method further comprises:
receiving, by the wireless communication terminal from the second wireless communication node via the first wireless communication node, a key for the user plane connection and an identifier of the key for the user plane connection; and
establishing or updating, by the wireless communication terminal, the user plane connection based on the key for the user plane connection and the identifier of the key for the user plane connection.

Preferably, the method further comprises:
transmitting, by the wireless communication terminal to the second wireless communication node via the first wireless communication node, an identifier of a first key;
receiving, by the wireless communication terminal from the second wireless communication node via the first wireless communication node, at least one of: the first key serving as the key for the user plane connection, the identifier of the first key, a valid period of the first key a second key serving as an updated key for the user plane connection, the identifier of the second key, or a valid period of the second key; and
establishing or updating, by the wireless communication terminal, the user plane connection based on at least one of: the first key, the identifier of the first key, the valid period of the first key, the second key, the identifier of the second key, or the valid period of the second key.

Preferably, the method further comprises:
transmitting, by the wireless communication terminal to the second wireless communication node via the first wireless communication node, a key refresh request via the uplink message, wherein the key refresh request comprises at least one of an identifier of the second wireless communication node or a key identifier;
receiving, by the wireless communication terminal from the second wireless communication node via the first wireless communication node, at least one of: an updated key for the user plane connection, the identifier of the updated key, or a valid period of the updated key; and
establishing or updating, by the wireless communication terminal, the user plane connection based on at least one of: the updated key, the identifier of the updated key, or the valid period of the updated key.

Preferably, the method further comprises:
transmitting, by the wireless communication terminal to the first wireless communication node, a key identifier to allow the first wireless communication node to acquire a key corresponding to the key identifier and transmit the key and the key identifier to the second wireless communication node; and
receiving, by the wireless communication terminal from the first wireless communication node, a key derivation indicator indicating the wireless communication terminal to derive the key corresponding to the key identifier; and
establishing or updating, by the wireless communication terminal, the user plane connection based on the key identifier and the derived key corresponding to the key identifier.

Preferably, the method further comprises:
generating, by the wireless communication terminal, the key corresponding to the key identifier according to at least one of: an uplink non-access stratum, NAS, count, a key for a communication between the first wireless communication node and the wireless communication terminal, or a Subscription Permanent Identifier, SUPI.

Another aspect of the present disclosure relates to a wireless communication method. In an embodiment, the wireless communication method includes: transmitting, by a second wireless communication node to a first wireless communication node, a request message to request the first wireless communication node transmitting to a wireless communication terminal security related information to allow the wireless communication terminal to establish or update a user plane connection between the wireless communication terminal and the second wireless communication node, wherein the user plane connection is protected based on the security related information.

Various embodiments may preferably implement the following features:

Preferably, the security related information comprises at least one of:
a key for the user plane connection;
an identifier of a key for the user plane connection;
a key derivation indicator indicating the wireless communication terminal to derive a key for the user plane connection; or
a valid period of a key for the user plane connection.

Preferably, the method further comprises:
transmitting, by the second wireless communication node to the first wireless communication node, user plane information indicating the wireless communication terminal performing the positioning via the user plane connection.

Preferably, the user plane information comprises at least one of:
an identifier of the wireless communication terminal;
an identifier of a key for the user plane connection; or
a key for the user plane connection.

Preferably, the method further comprises:
receiving, by the second wireless communication node from the first wireless communication node, a request message comprising an identifier of the wireless communication terminal.

Preferably, the method further comprises:
transmitting, by the second wireless communication node to the wireless communication terminal via the first wireless communication node, a key for the user plane connection and an identifier of the key for the user plane connection.

Preferably, the method further comprises:
receiving, by the second wireless communication node from the wireless communication terminal via the first wireless communication node, an identifier of a first key;
acquiring, by the second wireless communication node from a management function based on the identifier of the first key, at least one of: the first key serving as the key for the user plane connection, the identifier of the first key, a valid period of the first key a second key serving as an updated key for the user plane connection, the identifier of the second key, or a valid period of the second key; and
transmitting, by the second wireless communication node to the wireless communication terminal via the first wireless communication node, at least one of: the first key, the identifier of the first key, the valid period of the first key, the second key, the identifier of the second key, or the valid period of the second key.

Preferably, the method further comprises:
receiving, by the second wireless communication node from the wireless communication terminal via the first wireless communication node, a key refresh request via the uplink message, wherein the key refresh request comprises at least one of an identifier of the second wireless communication node or a key identifier;
acquiring, by the second wireless communication node from a management function based on the identifier of the first key, at least one of: an updated key for the user plane connection, the identifier of the updated key, or a valid period of the updated key; and
transmitting, by the second wireless communication node to the wireless communication terminal via the first wireless communication node, at least one of: the updated key, the identifier of the updated key, or the valid period of the updated key.

Preferably, the method further comprises:
acquiring, by the first wireless communication node, a key corresponding to the key identifier; and
receiving, by the second wireless communication node from the first wireless communication node, a key for the user plane connection and a key identifier corresponding to the key for the user plane connection.

Another aspect of the present disclosure relates to a first wireless communication node. In an embodiment, the first wireless communication node includes a communication unit and a processor. The processor is configured to: receive, via the communication unit from a wireless communication terminal, an uplink message for a user plane connection between the wireless communication terminal and a second wireless communication node; and transmit, via the communication unit to the wireless communication terminal, security related information in response to the uplink message to allow the wireless communication terminal to establish or update the user plane connection between the wireless communication terminal and a second wireless communication node, wherein the user plane connection is protected based on the security related information.

Another aspect of the present disclosure relates to a wireless communication terminal. In an embodiment, the wireless communication terminal includes a communication unit and a processor. The processor is configured to: transmit, via the communication unit to a first wireless communication node, an uplink message for a user plane connection between the wireless communication terminal and a second wireless communication node; receive, via the communication unit from the first wireless communication node, security related information; and establish or update the user plane connection between the wireless communication terminal and the second wireless communication node, wherein the user plane connection is protected based on the security related information.

Another aspect of the present disclosure relates to a second wireless communication node. In an embodiment, the second wireless communication node includes a communication unit and a processor. The processor is configured to: transmit, via the communication unit to a first wireless communication node, a request message to request the first wireless communication node transmitting to a wireless communication terminal security related information to allow the wireless communication terminal to establish or update a user plane connection between the wireless communication terminal and the second wireless communication node, wherein the user plane connection is protected based on the security related information.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompanying drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF DRAWINGS

FIG. 1 shows a schematic diagram of a network according to an embodiment of the present disclosure.

FIG. 2 shows a schematic diagram of a procedure according to an embodiment of the present disclosure.

FIG. 3 shows a schematic diagram of a procedure according to an embodiment of the present disclosure.

FIG. 4 shows a schematic diagram of a procedure according to an embodiment of the present disclosure.

FIG. 5 shows a schematic diagram of a procedure according to an embodiment of the present disclosure.

FIG. 6 shows an example of a schematic diagram of a wireless communication terminal according to an embodiment of the present disclosure.

FIG. 7 shows an example of a schematic diagram of a wireless communication node according to an embodiment of the present disclosure.

FIGS. 8 to 10 show flowcharts of wireless communication methods according to some embodiments of the present disclosure.

### DETAILED DESCRIPTION

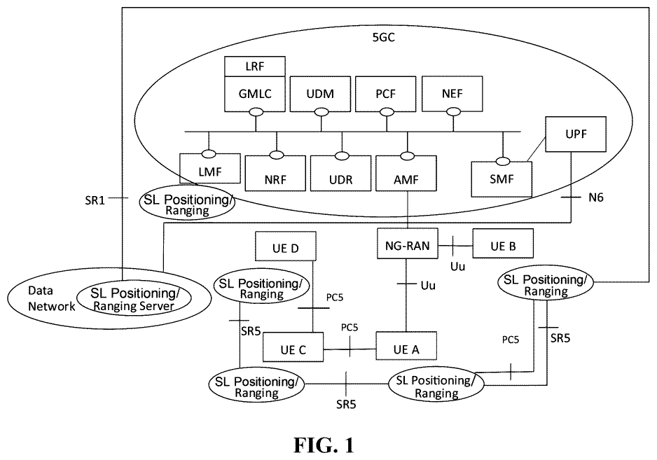

FIG. 1 shows a schematic diagram of a network according to an embodiment of the present disclosure. In some embodiments, the network functions (NFs) in the 5GC include:
Access and Mobility Management Function (AMF): Manages access and mobility-related functions such as authentication, security, session management, and mobility management for user devices (UE) in the network.
Session Management Function (SMF): Handles session-related functions such as the establishment, modification, and termination of data sessions for the UE. It ensures efficient data routing and manages Quality of Service (QoS) policies.
User Data Repository (UDR): Stores and manages user-related data, including subscription and profile information, authentication credentials, and service-related data. It provides the necessary information for various network functions.
Policy Control Function (PCF): Enforces policy rules and manages QoS for individual users or groups of users. It ensures that network resources are allocated appropriately and that service-level agreements are met.
Network Exposure Function (NEF): Enables authorized third-party applications and services to access network data and functions securely. It provides standardized interfaces for external service providers to interact with the 5GC.
Network Repository Function (NRF): Maintains a registry of network functions and their corresponding addresses in the 5GC. It assists in the discovery and selection of network functions during service setup and operation.
Location Retrieval Function (LRF): Retrieves location information of UEs for location-based services. It provides the necessary positioning data to support services that require location awareness.
Gateway Mobile Location Center (GMLC): Provides location-based services by retrieving location information from the LRF and delivering it to authorized applications or services.
Location Management Function (LMF): Manages location-related functions, including tracking the location of UEs, updating location information, and supporting mobility management in the network.

In some embodiments, the 5GC collaborates with the NG-RAN and UE to enable seamless connectivity and advanced services. The NG-RAN provides the wireless access network for UEs, while the 5GC manages the core network functions.

In some embodiments, ranging-based service provides the distance between two or more UEs and/or the direction of one UE (i.e., Target UE) from another UE (i.e., Reference UE) via the PC5 interface (also referred to as PC5).

In some embodiments, Sidelink Positioning utilizes the PC5 interface to provide absolute location, relative position, or ranging information of a UE. By using Sidelink Positioning, the location of a Target UE can be determined based on the information obtained from a located UE.

In some embodiments, the Ranging/SL Positioning service can be accessed by authorized SL Positioning Client UEs, 5GC NFs, or AFs (application functions) to obtain relative position or distance/direction results between UEs capable of Ranging/SL Positioning. Additionally, authorized 5GC NFs, AFs, or the LCS (Location Services) client can use the service to obtain the absolute position of a Target UE if it is determined that Ranging/SL Positioning is applicable.

In some embodiments, the UE may trigger the user plane connection establishment if the UE does not have a user plane connection (also referred to as user plane in the present disclosure) with the LMF. In some embodiments, the UE may trigger the user plane connection update if the UE determines to refresh a key for a user plane connection. Some embodiments of the present disclosure provide a method to establish or update the security user plane connection for the UE and LMF.

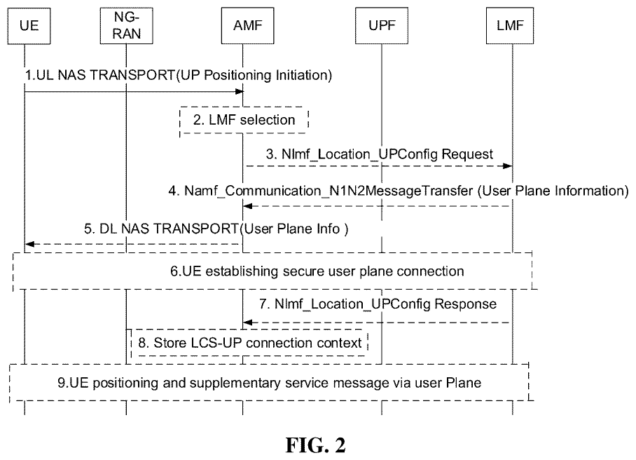

FIG. 2 shows a schematic diagram of a procedure according to an embodiment of the present disclosure. In FIG. 2, a procedure triggered by the UE to support positioning over the user plane connection between the UE and the LMF is adopted. In some embodiments, the procedure includes at least one of the following operations, steps and/or configurations.
1. The UE may send a request (e.g., a user plane establishment request) to the AMF (e.g., via the NAS Message). In some embodiments, the request includes a UP (uplink) Positioning Initiation (e.g., for a positioning related service). In some embodiments, the UE may send the request to the AMF if the UE decides to prepare a user plane connection for upcoming positioning requests.
2. [Conditional] The AMF may select an LMF. In some embodiments, the AMF may select an LMF based on the UE ID. In some embodiments, the AMF may select an LMF capable of establishing a user plane session for positioning with the UE. In some embodiments, the AMF may select an LMF if the UE is authorized based on the UE Subscription to use the user plane positioning.
3. [Conditional] The AMF sends a request (e.g., an Nlmf_Location_UPConfig Request) to the LMF. In some embodiments, the request to the LMF is to request the setup of an LCS(Location Services)-UP connection.
4. [Conditional] The LMF sends response information (e.g., user plane information) to the AMF. In some embodiments, the response information (e.g., user plane information) is transmitted via a Namf_Communication_N1N2MessageTransfer message. In some embodiments, the response information (e.g., user plane information) may be transmitted if the LMF accepts utilizing the user plane for positioning and there is no established secure user plane connection between the UE and LMF. In some embodiments, the response information (e.g., user plane information) may be transmitted to the AMF to indicate that the UE accepts and utilizes the user plane connection for positioning. In some embodiments, the response information includes the user plane positioning address of the LMF and security-related information.
5. [Conditional] The AMF transmits the response information (e.g., user plane information) to the UE. In some embodiments, the AMF transmits the response information (e.g., user plane information) to the UE via a DL NAS TRANSPORT message. In some embodiments, the AMF transmits the response information (e.g., user plane information) to the UE when the AMF receives the response information (e.g., user plane information) from the LMF.
6. [Conditional] The UE establishes a secured user plane connection with the LMF.
7. [Conditional] The LMF responds to the AMF that the user plane connection between the UE and LMF has been established (e.g., by transmitting a Nlmf_Location_UPConfig Response to the AMF).
8. [Conditional] The AMF stores the LCS-UP connection context as part of the UE context.
9. [Conditional] After the secure user plane connection is established, if the LMF determines to utilize the user plane connection for positioning upon receiving a positioning request from the AMF, or if the UE determines to utilize the user plane connection for positioning, LPP messages are transferred between the UE and LMF for UE-based positioning, UE-assisted positioning, and the delivery of assistance data. Supplementary services event report messages from the UE may also be transferred to the LMF via the established user plane connection.

In some embodiments of the present disclosure, after receiving a request for the user plane connection from the UE via AMF, the LMF may generate the key and key ID (identifier) used for a user plane connection to the UE via the AMF.

In some embodiments of the present disclosure, after receiving a request for the user plane connection from the UE via AMF, the LMF gets the key and key ID used for the user plane connection from another NF, and sends the key and key ID to the UE via the AMF.

In some embodiments of the present disclosure, after receiving a request for the user plane connection request from the UE, the AMF may generate the key and key ID based on a key used between the AMF and the UE (referred to as KAMF in the present disclosure), and sends the key and key ID used for the user plane connection to the UE and the LMF.

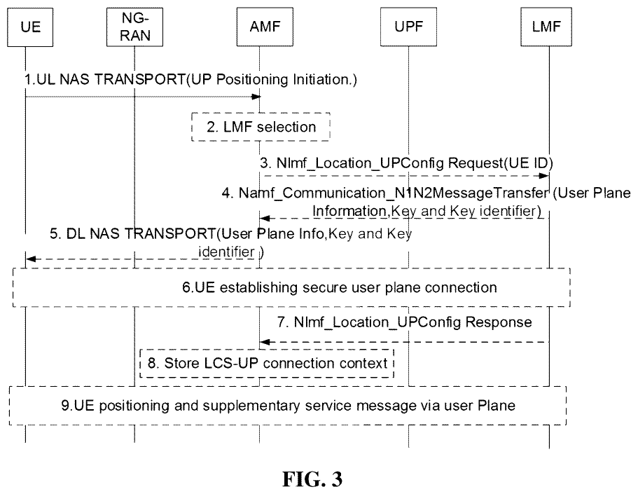

FIG. 3 shows a schematic diagram of a procedure according to an embodiment of the present disclosure. In FIG. 3, a procedure triggered by the UE to support positioning over the user plane connection between the UE and the LMF is adopted. In some embodiments, the procedure includes at least one of the following operations, steps and/or configurations.
1. The UE may send a request (e.g., a user plane establishment request or an update request for an established user plane connection) to the AMF (e.g., via the NAS Message). In some embodiments, the request includes a UP (uplink) Positioning Initiation (e.g., for a positioning related service). In some embodiments, the UE may send the request to the AMF if the UE decides to prepare a user plane connection for upcoming positioning requests.
2. The AMF may select an LMF. In some embodiments, the AMF may select an LMF based on the UE ID. In some embodiments, the AMF may select an LMF capable of establishing or updating a user plane session for positioning with the UE. In some embodiments, the AMF may select an LMF if the UE is authorized based on the UE Subscription to use the user plane positioning.
3. The AMF sends a request (e.g., an Nlmf_Location_UPConfig Request) to the LMF. In some embodiments, the request to the LMF is to request the setup of an LCS(Location Services)-UP connection. In some embodiments, the request to the LMF may include the UE ID of the UE.
4. The LMF sends response information (e.g., user plane information) to the AMF. In some embodiments, the response information (e.g., user plane information) is transmitted via a Namf_Communication_N1N2MessageTransfer message. In some embodiments, the response information (e.g., user plane information) may be transmitted if the LMF accepts utilizing the user plane for positioning and there is no established secure user plane connection between the UE and LMF. In some embodiments, the response information (e.g., user plane information) may be transmitted if the LMF accepts refreshing the user plane for positioning. In some embodiments, the response information (e.g., user plane information) may be transmitted to the AMF to indicate that the UE accepts and utilizes the user plane connection for positioning. In some embodiments, the response information includes the user plane positioning address of the LMF and security-related information. In some embodiments, the response information transmitted to the AMF may include a key and a corresponding key identifier. In some embodiments, the key and the corresponding key identifier can be generated by the LMF.
5. The AMF transmits the response information (e.g., user plane information) to the UE. In some embodiments, the AMF transmits the response information (e.g., user plane information) to the UE via a DL NAS TRANSPORT message. In some embodiments, the AMF transmits the response information (e.g., user plane information) to the UE when the AMF receives the response information (e.g., user plane information) from the LMF. In some embodiments, the response information transmitted to the UE may include a key and a corresponding key identifier.
6. The UE establishes or updates a secured user plane connection with the LMF (e.g., based on the key and a corresponding key identifier).
7. The LMF responds to the AMF that the user plane connection between the UE and LMF has been established or updated (e.g., by transmitting a Nlmf_Location_UPConfig Response to the AMF).
8. The AMF stores the LCS-UP connection context as part of the UE context.
9. After the secure user plane connection is established or updated, if the LMF determines to utilize the user plane connection for positioning upon receiving a positioning request from the AMF, or if the UE determines to utilize the user plane connection for positioning, LPP messages are transferred between the UE and LMF for UE-based positioning, UE-assisted positioning, and the delivery of assistance data. Supplementary services event report messages from the UE may also be transferred to the LMF via the established or updated user plane connection.

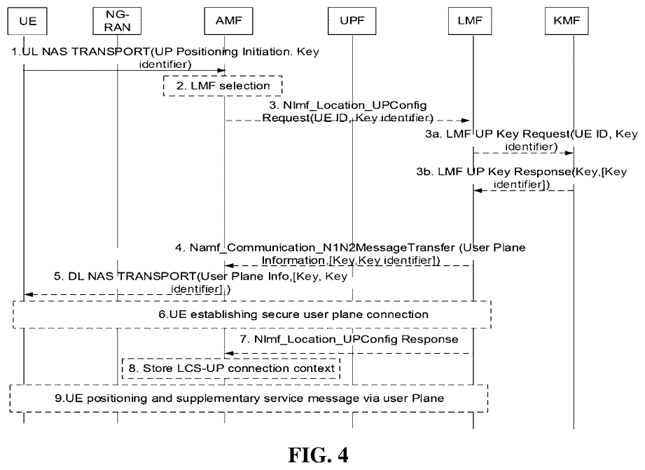

FIG. 4 shows a schematic diagram of a procedure according to an embodiment of the present disclosure. In FIG. 4, a procedure triggered by the UE to support positioning over the user plane connection between the UE and the LMF is adopted. In some embodiments, the procedure includes at least one of the following operations, steps and/or configurations.
1. The UE may send a request (e.g., a user plane establishment request or an update request for an established user plane connection) to the AMF (e.g., via the NAS Message). In some embodiments, the request includes a UP (uplink) Positioning Initiation (e.g., for a positioning related service). In some embodiments, the UE may send the request to the AMF if the UE decides to prepare a user plane connection for upcoming positioning requests. In some embodiments, the request may include a key identifier to indicate a key. In some embodiments, the indicated key is used for the user plane connection. In some embodiments, the key is available for the UE to protect the user plane connection (e.g., encrypt the data thereon).
2. The AMF may select an LMF. In some embodiments, the AMF may select an LMF capable of establishing or updating a user plane session for positioning with the UE. In some embodiments, the AMF may select an LMF if the UE is authorized based on the UE Subscription to use the user plane positioning. In some embodiments, the AMF may select the LMF based on at least one of the UE ID and/or the key identifier.
3. The AMF sends a request (e.g., an Nlmf_Location_UPConfig Request) to the LMF. In some embodiments, the request to the LMF is to request the setup of an LCS(Location Services)-UP connection. In some embodiments, the request to the LMF includes at least one of the UE ID and/or the key identifier.
3a. The LMF sends a request message (e.g., an LMF UP Key Request message) to the Key Management Function (KMF). In some embodiments, the request message to the KMF is to get a key from the KMF. In some embodiments, the request message includes at least one of the UE ID, and/or the key identifier. In some embodiments, the LMF selects the KMF based on at least one of the UE ID and/or the key identifier. In some embodiments, if the LMF can find a valid key (e.g., stored locally or in a storage entity) based on the key identifier, this operation can be omitted.
3b. The KMF sends a response message (e.g., an LMF UP Key Response message) to the LMF. In some embodiments, the KMF sends a response message to the LMF based on the key identifier. In some embodiments, the KMF sends a response message to the LMF if the KMF can find a key based on the key identifier. In some embodiments, the response message to the LMF includes a key and optionally a validity period of the key.

In some embodiments, if the KMF wants to refresh the key, and/or key identifier, the KMF can generate a new key and a new key identifier corresponding to the new key. In some embodiments, if the new key and new key identifier are generated, the response message to the LMF includes the new key, a validity period of the new key, and/or the new key identifier.

In some embodiments, steps 3a and 3b may be omitted if the LMF can find a valid key (e.g., stored locally or in a storage entity) based on the key identifier.
4. The LMF sends response information (e.g., user plane information) to the AMF. In some embodiments, the response information (e.g., user plane information) is transmitted via a Namf_Communication_N1N2MessageTransfer message. In some embodiments, the response information (e.g., user plane information) may be transmitted if the LMF accepts utilizing the user plane for positioning and there is no established secure user plane connection between the UE and LMF. In some embodiments, the response information (e.g., user plane information) may be transmitted if the LMF accepts refreshing the user plane for positioning. In some embodiments, the response information (e.g., user plane information) may be transmitted to the AMF to indicate that the UE accepts and utilizes the user plane connection for positioning. In some embodiments, the response information to the AMF includes the user plane positioning address of the LMF and security-related information. In some embodiments, the response information to the AMF includes at least one of: the key (e.g., the key corresponding to the key ID from the UE found by the LMF, the key generated by the KMF based on the key ID from the UE, or the key generated by the KMF), the key ID corresponding to the key, and/or a validity period of the key.
5. The AMF transmits the response information (e.g., user plane information) to the UE. In some embodiments, the AMF transmits the response information (e.g., user plane information) to the UE via a DL NAS TRANSPORT message. In some embodiments, the AMF transmits the response information (e.g., user plane information) to the UE when the AMF receives the response information (e.g., user plane information) from the LMF.

In some embodiments, the response information to the UE includes at least one of: the key (e.g., the key corresponding to the key ID from the UE found by the LMF, the key generated by the KMF based on the key ID from the UE, or the key generated by the KMF), the key ID corresponding to the key, and/or a validity period of the key.
6. The UE establishes or updates a secured user plane connection with the LMF. In some embodiments, the UE establishes or updates the secured user plane connection based on at least one of: the key (e.g., the key corresponding to the key ID from the UE found by the LMF, the key generated by the KMF based on the key ID from the UE, or the key generated by the KMF), the key ID corresponding to the key, and/or a validity period of the key.
7. The LMF responds to the AMF that the user plane connection between the UE and LMF has been established or updated (e.g., by transmitting a Nlmf_Location_UPConfig Response to the AMF).
8. The AMF stores the LCS-UP connection context as part of the UE context.
9. After the secure user plane connection is established or updated, if the LMF determines to utilize the user plane connection for positioning upon receiving a positioning request from the AMF, or if the UE determines to utilize the user plane connection for positioning, LPP messages are transferred between the UE and LMF for UE-based positioning, UE-assisted positioning, and the delivery of assistance data. Supplementary services event report messages from the UE may also be transferred to the LMF via the established or updated user plane connection.

In some embodiments, the procedure described above can be adopted for the UE to refresh the key. For example, in step 1 described above, the UE may send the request to the AMF (e.g., via the NAS Message) indicating refreshing the key. The request (e.g., a key refresh request) may include at least one of an LMF ID, and/or a key identifier. In step 1 described above, the AMF may transmit the request including the at least one of the LMF ID, and/or the key identifier to LMF. The LMF may refresh the key with or without the KMF based on the request received from the AMF, and transmits at least one of the refreshed key, the key ID corresponding to the refreshed key, and/or the validity period of the refreshed key to the UE via the AMF. Details in this regards can be ascertained by referring to step 3a to step 9, and will not be described herein.

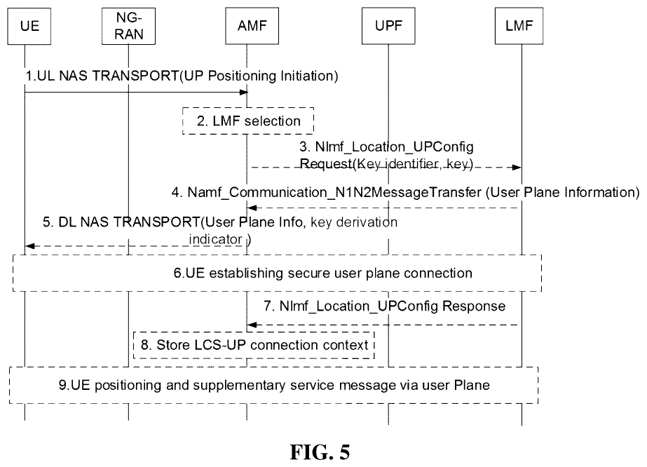

FIG. 5 shows a schematic diagram of a procedure according to an embodiment of the present disclosure. In FIG. 5, a procedure triggered by the UE to support positioning over the user plane connection between the UE and the LMF is adopted. In some embodiments, the procedure includes at least one of the following operations, steps and/or configurations.
1. The UE may send a request (e.g., a user plane establishment request or an update request for an established user plane connection) to the AMF (e.g., via the NAS Message). In some embodiments, the request includes a UP (uplink) Positioning Initiation (e.g., for a positioning related service). In some embodiments, the UE may send the request to the AMF if the UE decides to prepare a user plane connection for upcoming positioning requests. In some embodiments, the request includes a key ID to indicate a key used for the user plane connection.
2. The AMF may select an LMF. In some embodiments, the AMF may select an LMF based on the UE ID. In some embodiments, the AMF may select an LMF capable of establishing or updating a user plane session for positioning with the UE. In some embodiments, the AMF may select an LMF if the UE is authorized based on the UE Subscription to use the user plane positioning.
3. The AMF sends a request (e.g., an Nlmf_Location_UPConfig Request) to the LMF. In some embodiments, the request to the LMF is to request the setup of an LCS(Location Services)-UP connection. In some embodiments, the request to the LMF includes at least one of the UE ID of the UE, the key ID and the key. In some embodiments, the AMF may generate the key based on at least one of the NAS (uplink non-access stratum) Count, the key used between the AMF and the UE (e.g., KAMF), and/or the SUPI (Subscription Permanent Identifier).
4. The LMF sends response information (e.g., user plane information) to the AMF. In some embodiments, the response information (e.g., user plane information) is transmitted via a Namf_Communication_N1N2MessageTransfer message. In some embodiments, the response information (e.g., user plane information) may be transmitted if the LMF accepts utilizing the user plane for positioning and there is no established secure user plane connection between the UE and LMF. In some embodiments, the response information (e.g., user plane information) may be transmitted if the LMF accepts refreshing the user plane for positioning. In some embodiments, the response information (e.g., user plane information) may be transmitted to the AMF to indicate that the UE accepts and utilizes the user plane connection for positioning. In some embodiments, the response information includes the user plane positioning address of the LMF and security-related information.
5. The AMF transmits the response information (e.g., user plane information) to the UE. In some embodiments, the AMF transmits the response information (e.g., user plane information) to the UE via a DL NAS TRANSPORT message. In some embodiments, the AMF transmits the response information (e.g., user plane information) to the UE when the AMF receives the response information (e.g., user plane information) from the LMF. In some embodiments, the response information to the UE may include a key derivation indicator.
6. The UE establishes or updates a secured user plane connection with the LMF. In some embodiments, the UE establishes or updates a secured user plane connection with the LMF based on a key. In some embodiments, the UE may derive the key for establishing the secured user plane connection or the updated key for the user plane connection based on the key derivation indicator. In some embodiments, the UE may derive the key in the same way that the AMF generates the key in response to that the UE receives the key derivation indicator from the AMF. That is, the UE may generate the key based on the at least one of the NAS Count, the key used between the AMF and the UE (e.g., KAMF), and/or the SUPI.
7. The LMF responds to the AMF that the user plane connection between the UE and LMF has been established or updated (e.g., by transmitting a Nlmf_Location_UPConfig Response to the AMF).
8. The AMF stores the LCS-UP connection context as part of the UE context.
9. After the secure user plane connection is established or updated, if the LMF determines to utilize the user plane connection for positioning upon receiving a positioning request from the AMF, or if the UE determines to utilize the user plane connection for positioning, LPP messages are transferred between the UE and LMF for UE-based positioning, UE-assisted positioning, and the delivery of assistance data. Supplementary services event report messages from the UE may also be transferred to the LMF via the established or updated user plane connection.

It is understood that the procedures described above can be used to generate a key for establishing a secured user plane connection (e.g., the key is used to protect (e.g., encrypt) the data transmitted on the secured user plane connection) or generate a refreshed key to update the user plane connection with the refreshed key (e.g., the refreshed key is used to protect (e.g., encrypt) the data transmitted on the updated user plane connection).

In the paragraphs below, details will be described along with some examples, but the present disclosure is not limited to the example below.

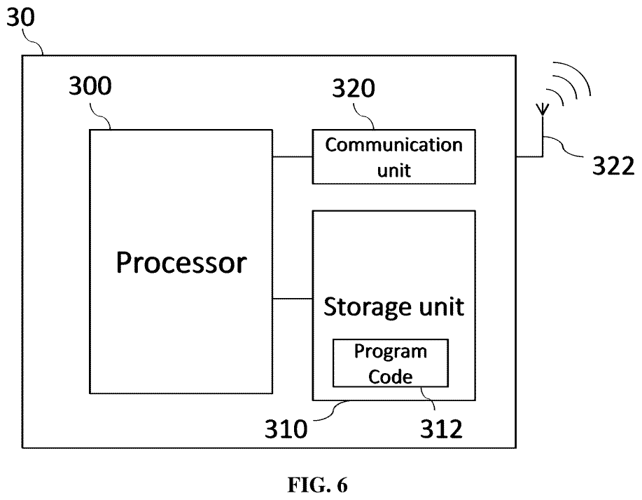

FIG. 6 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may be used to implement the UE described in this disclosure. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 or via wiring.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described in this disclosure. In some embodiments, the processor 300 and the communication unit 320 collaboratively perform the operations described in this disclosure. For example, the processor 300 performs operations and transmit or receive signals, message, and/or information through the communication unit 320.

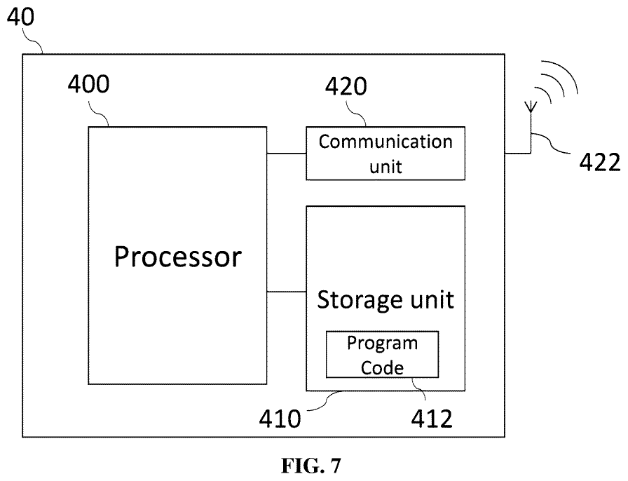

FIG. 7 relates to a diagram of a wireless communication node 40 according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may be used to implement the node, the network, the network functions (e.g., the AMF, the LMF, etc.), or the network node described in this disclosure. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an embodiment, the communication unit 420 transmits and receives the signals via at least one antenna 422 or via wiring.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the AMF or the LMF described in this disclosure. In some embodiments, the processor 400 and the communication unit 420 collaboratively perform the operations described in this disclosure. For example, the processor 400 performs operations and transmit or receive signals through the communication unit 420.

A wireless communication method is also provided according to an embodiment of the present disclosure. In an embodiment, the wireless communication method may be performed by using a wireless communication node (e.g., an AMF). In an embodiment, the wireless communication node may be implemented by using the wireless communication node 40 described in this disclosure, but is not limited thereto.

Referring to FIG. 8, in an embodiment, the wireless communication method includes: receiving, by a first wireless communication node from a wireless communication terminal, an uplink message for a user plane connection between the wireless communication terminal and a second wireless communication node; and transmitting, by the first wireless communication node to the wireless communication terminal, security related information in response to the uplink message to allow the wireless communication terminal to establish or update the user plane connection between the wireless communication terminal and a second wireless communication node, wherein the user plane connection is protected based on the security related information.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 30 described in this disclosure, but is not limited thereto.

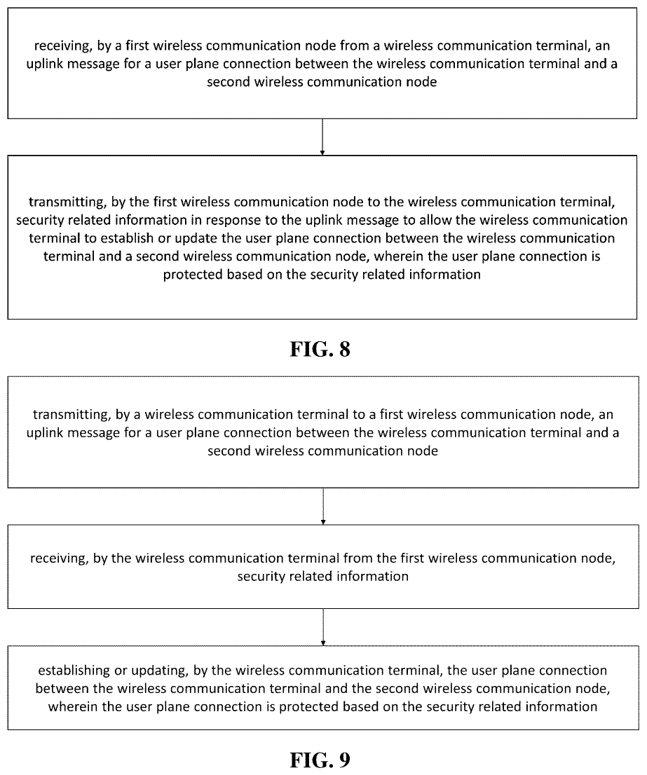

Referring to FIG. 9, in an embodiment, the wireless communication method includes transmitting, by a wireless communication terminal to a first wireless communication node, an uplink message for a user plane connection between the wireless communication terminal and a second wireless communication node; receiving, by the wireless communication terminal from the first wireless communication node, security related information; and establishing or updating, by the wireless communication terminal, the user plane connection between the wireless communication terminal and the second wireless communication node, wherein the user plane connection is protected based on the security related information.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., an LMF). In an embodiment, the wireless communication node may be implemented by using the wireless communication node 40 described in this disclosure, but is not limited thereto.

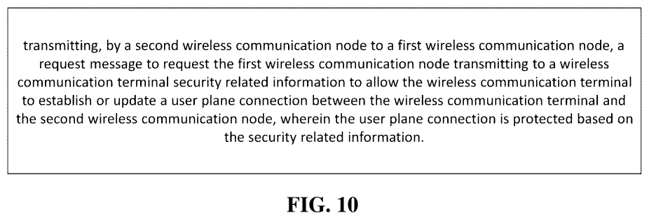

Referring to FIG. 10, in an embodiment, the wireless communication method includes transmitting, by a second wireless communication node to a first wireless communication node, a request message to request the first wireless communication node transmitting to a wireless communication terminal security related information to allow the wireless communication terminal to establish or update a user plane connection between the wireless communication terminal and the second wireless communication node, wherein the user plane connection is protected based on the security related information.

Details in this regard can be ascertained with reference to the paragraphs above, and will not be repeated herein.

In some embodiments, the wireless communication terminal used in the present disclosure may indicate the UE described above.

In some embodiments, the first wireless communication node used in the present disclosure may indicate the AMF described above.

In some embodiments, the second wireless communication node used in the present disclosure may indicate the LMF described above.

In some embodiments, the management function used in the present disclosure may be the KMF described above.

In some embodiments, the uplink message used in the present disclosure may be an UL NAS TRANSPORT message described above, which may include the UP Positioning Initiation or the key refresh request described above.

In some embodiments, the first key used in the present disclosure may be the key used for establishing or updating the user plane connection when the KMF does not refresh the key. Details in this regard can be ascertained with reference to the paragraphs above, and will not be repeated herein.

In some embodiments, the second key used in the present disclosure may be the key refreshed by the KMF when the KMF decides to refresh the key, and is used for establishing or updating the user plane connection. Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is understood that, in the present disclosure, the term “and/or” or symbol “/” may include any and all combinations of one or more of the associated listed items. For example, A and/or B and/or C includes any and all combinations of one or more of A, B, and C, including A, B, C, A and B, A and C, B and C, and a combination of A and B and C. Likewise, A/B/C includes any and all combinations of one or more of A, B, and C, including A, B, C, A and B, A and C, B and C, and a combination of A and B and C.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a first wireless communication node from a wireless communication terminal, an uplink message for a user plane connection between the wireless communication terminal and a second wireless communication node; and
transmitting, by the first wireless communication node to the wireless communication terminal, security related information in response to the uplink message to allow the wireless communication terminal to generate or update a key for protecting the user plane connection between the wireless communication terminal and a second wireless communication node.

2. The wireless communication method of claim 1, wherein the security related information comprises at least one of:
a key for the user plane connection;
an identifier of a key for the user plane connection;
a key derivation indicator indicating the wireless communication terminal to derive a key for the user plane connection; or
a valid period of a key for the user plane connection.

3-6. (canceled)

7. The wireless communication method of claim 1, further comprising:
receiving, by the first wireless communication node from the wireless communication terminal, an identifier of a first key;
transmitting, by the first wireless communication node to the second wireless communication node, the identifier of the first key;
receiving, by the first wireless communication node from the second wireless communication node, at least one of: the first key serving as the key for the user plane connection, the identifier of the first key, a valid period of the first key a second key serving as an updated key for the user plane connection, the identifier of the second key, or a valid period of the second key; and
transmitting, by the first wireless communication node to the wireless communication terminal, at least one of: the first key, the identifier of the first key, the valid period of the first key, the second key, the identifier of the second key, or the valid period of the second key.

8. The wireless communication method of claim 1, further comprising:
receiving, by the first wireless communication node from the wireless communication terminal, a key refresh request via the uplink message, wherein the key refresh request comprises at least one of an identifier of the second wireless communication node or a key identifier;
transmitting, by the first wireless communication node to the second wireless communication node, the key refresh request;
receiving, by the first wireless communication node from the second wireless communication node, at least one of: an updated key for the user plane connection, the identifier of the updated key, or a valid period of the updated key; and
transmitting, by the first wireless communication node to the wireless communication terminal, at least one of: the updated key, the identifier of the updated key, or the valid period of the updated key;
wherein the method further comprises:
selecting, by the first wireless communication node, the second wireless communication node based on at least one of the identifier of the first key or an identifier of the wireless communication terminal.

9. (canceled)

10. The wireless communication method of claim 2, further comprising:
transmitting, by the first wireless communication node to the second wireless communication node, the key for the user plane connection and the key identifier of the key for the user plane connection.

11. The wireless communication method of claim 2, further comprising:
generating, by the first wireless communication node, the key for the user plane connection according to a key for a communication between the first wireless communication node and the wireless communication terminal.

12. A wireless communication method comprising:
transmitting, by a wireless communication terminal to a first wireless communication node, an uplink message for a user plane connection between the wireless communication terminal and a second wireless communication node;
receiving, by the wireless communication terminal from the first wireless communication node, security related information; and
generating or updating, by the wireless communication terminal, a key for protecting the user plane connection between the wireless communication terminal and the second wireless communication node.

13. The wireless communication method of claim 12, wherein the security related information comprises at least one of:
a key for the user plane connection;
an identifier of a key for the user plane connection;
a key derivation indicator indicating the wireless communication terminal to derive a key for the user plane connection; or
a valid period of a key for the user plane connection.

14-16. (canceled)

17. The wireless communication method of claim 12, further comprising:
transmitting, by the wireless communication terminal to the second wireless communication node via the first wireless communication node, an identifier of a first key;
receiving, by the wireless communication terminal from the second wireless communication node via the first wireless communication node, at least one of: the first key serving as the key for the user plane connection, the identifier of the first key, a valid period of the first key a second key serving as an updated key for the user plane connection, the identifier of the second key, or a valid period of the second key; and
establishing or updating, by the wireless communication terminal, the user plane connection based on at least one of: the first key, the identifier of the first key, the valid period of the first key, the second key, the identifier of the second key, or the valid period of the second key.

18. The wireless communication method of claim 12, further comprising:
transmitting, by the wireless communication terminal to the second wireless communication node via the first wireless communication node, a key refresh request via the uplink message, wherein the key refresh request comprises at least one of an identifier of the second wireless communication node or a key identifier;
receiving, by the wireless communication terminal from the second wireless communication node via the first wireless communication node, at least one of: an updated key for the user plane connection, the identifier of the updated key, or a valid period of the updated key; and
establishing or updating, by the wireless communication terminal, the user plane connection based on at least one of: the updated key, the identifier of the updated key, or the valid period of the updated key.

19. The wireless communication method of claim 12, further comprising:
transmitting, by the wireless communication terminal to the first wireless communication node, a key identifier to allow the first wireless communication node to acquire a key corresponding to the key identifier and transmit the key and the key identifier to the second wireless communication node; and
receiving, by the wireless communication terminal from the first wireless communication node, a key derivation indicator indicating the wireless communication terminal to derive the key corresponding to the key identifier; and
establishing or updating, by the wireless communication terminal, the user plane connection based on the key identifier and the derived key corresponding to the key identifier.

20. The wireless communication method of 13, further comprising:
generating, by the wireless communication terminal, the key for the user plane connection according to a key for a communication between the first wireless communication node and the wireless communication terminal.

21. A wireless communication method comprising:
transmitting, by a second wireless communication node to a first wireless communication node, a request message to request the first wireless communication node transmitting to a wireless communication terminal security related information to allow the wireless communication terminal to generate or update a key for protecting a user plane connection between the wireless communication terminal and the second wireless communication node.

22. The wireless communication method of claim 21, wherein the security related information comprises at least one of:
a key for the user plane connection;
an identifier of a key for the user plane connection;
a key derivation indicator indicating the wireless communication terminal to derive a key for the user plane connection; or
a valid period of a key for the user plane connection.

23-26. (canceled)

27. The wireless communication method of claim 21, further comprising:
receiving, by the second wireless communication node from the wireless communication terminal via the first wireless communication node, an identifier of a first key;
acquiring, by the second wireless communication node from a management function based on the identifier of the first key, at least one of: the first key serving as the key for the user plane connection, the identifier of the first key, a valid period of the first key a second key serving as an updated key for the user plane connection, the identifier of the second key, or a valid period of the second key; and
transmitting, by the second wireless communication node to the wireless communication terminal via the first wireless communication node, at least one of:
the first key, the identifier of the first key, the valid period of the first key, the second key, the identifier of the second key, or the valid period of the second key.

28. The wireless communication method of claim 21, further comprising:
receiving, by the second wireless communication node from the wireless communication terminal via the first wireless communication node, a key refresh request via the uplink message, wherein the key refresh request comprises at least one of an identifier of the second wireless communication node or a key identifier;
acquiring, by the second wireless communication node from a management function based on the identifier of the first key, at least one of: an updated key for the user plane connection, the identifier of the updated key, or a valid period of the updated key; and
transmitting, by the second wireless communication node to the wireless communication terminal via the first wireless communication node, at least one of: the updated key, the identifier of the updated key, or the valid period of the updated key.

29. The wireless communication method of claim 22, further comprising:
receiving, by the second wireless communication node from the first wireless communication node, the key for the user plane connection and the identifier of the key for the user plane connection.

30. A first wireless communication node, comprising:
a communication unit; and
a processor configured to perform the wireless communication method of claim 1.

31. (canceled)

32. A wireless communication terminal, comprising:
a communication unit; and
a processor configured to perform the wireless communication method of claim 12.

33. (canceled)

34. A second wireless communication node, comprising:
a communication unit; and
a processor configured to perform the wireless communication method of claim 21.

35. (canceled)

36. (canceled)
